(19) United States
(12) Patent Application Publication
(10) Pub. No.: US 2021/0130736 A1
(43) Pub. Date: May 6, 2021

(54) PROCESS FOR THE MANUFACTURE OF AN AQUEOUS COMPOSITION SUITABLE FOR PHYSICAL FOAMING

(71) Applicant: SOLVAY SA, Brussels (BE)

(72) Inventors: Philippe COEL, Brussels (BE); Laurence DEWALENS, Brussels (BE)

(21) Appl. No.: 16/472,762

(22) PCT Filed: Dec. 19, 2017
(86) PCT No.: PCT/EP2017/083469

§ 371 Date: Jun. 21, 2019

(30) Foreign Application Priority Data
Dec. 22, 2016 (EP) 16206250.9

(51) Int. Cl. C11D 1/75; C11D 11/00; C11D 3/00; C11D 3/20; C11D 3/39; C11D 3/48

(52) U.S. Cl. CPC C11D 1/75; C11D 11/0058; C11D 3/0094; C11D 3/3945; C11D 3/3947; C11D 3/48; C11D 3/3942; C11D 3/2079

(57) ABSTRACT

A process for the manufacture of an aqueous composition suitable for physical foaming comprising hydrogen peroxide, peracetic acid in an amount of at least 1 wt % and at least one amine oxide, said process comprising a step of adding at least one fatty acid in an amount of at least 0.1 wt % with regard to the total weight of the composition.

This application claims priority to European application No. EP 16206250.9 filed on Dec. 22, 2016 the whole content of this application being incorporated herein by reference for all purposes.

The present invention relates to a process for the manufacture of an aqueous composition suitable for physical foaming, more specifically to a foaming peracetic acid composition.

During recent years, increasing attention has been paid by industry and the general public in Western Europe and North America to the environmental effects of the many substances that are employed in modern life. One of the classes of substances which have hitherto been widely employed in disinfection comprises chlorine and oxychlorine derivatives thereof. Such compounds have been reported to generate under appropriate circumstances carcinogenic compounds and as a result, industry is seeking alternatives or replacements for such compounds in order to allay any residual public anxiety.

An alternative class of compounds comprises peroxygen compounds, of which one sub-class of especial interest comprises peracids which contain the moiety —CO—OOH. Peracids, like hydrogen peroxide, enjoy the substantial advantage of generating oxygen, either as such or in an active form during its deployment rather than chlorine or active chlorine species upon which environmentalists currently cast doubts. Furthermore, for a range of purposes such as disinfection, oxidation and bleaching, many of which are encountered domestically, peracids are more effective in general than hydrogen peroxide.

A number of the peracids are either liquid themselves or are produced conveniently in aqueous solution. Although such compositions are particularly appropriate for the treatment of or incorporation in liquid media, they are less appropriate for the treatment of solid surfaces, and particularly non-horizontal surfaces on account of the ability of liquid compositions to flow away from the point of contact. In consequence, and in order to extend the range of applications for peracids, it would be desirable to devise peracid-containing compositions that flowed less freely.

In principle, liquid compositions can be rendered less free-flowing by the incorporation of materials which thicken the liquid or introduce structure into the liquid. However, substances which have hitherto been effective thickeners for other liquids cannot be presumed automatically to be suitable for thickening liquid peracids or peracid solutions. This difficulty derives from the very same properties of the peracids that make them effective oxidising agents and bleaches. Interaction with thickeners during storage can result in the mutual decomposition of the peracid and the thickener, which in turn not only negates the beneficial effects of thickening, but also progressively removes the capability of the peracid to perform its desired task. It will be recognised that the problem is especially apparent in the case of peracids which are themselves either liquid or are present in solution. There is also a second important difficulty in attempting to thicken peracid solutions. The presence of the peracid and the corresponding carboxylic acid from which it can be derived, tends to significantly inhibit thickening. It is believed that the difficulty arises from interference of the peracid and/or carboxylic acid with aqueous structuring mechanisms which enable surfactants and like materials to thicken aqueous solutions. However, it will be understood that the instant invention does not depend upon the accuracy of the foregoing belief or explanation, but instead it relies upon the results actually demonstrated.

By comparison with soluble peracids, the problem can be somewhat diminished in the case of substantially insoluble solid peracids that are suspended in particulate form in aqueous media, because the peracid and the liquid constitute different physical phases that consequently minimise the extent of chemical interaction between them, and the thickening of the aqueous phase can occur with a lessened risk of interference from dissolved peracid species.

It will be understood that some other potential thickeners may initially or after a brief period of storage produce a much thickened composition, but one which is rather unstable, in that its viscosity falls away rapidly from its peak.

U.S. Pat. No. 6,828,294 discloses an aqueous composition suitable for use as a high-retention sanitizer, especially on irregular and/or non-horizontal surfaces and surfaces on which water does not readily spread, a method for sanitizing a surface using the composition, and kits comprising components of the composition. The composition is preferably applied as a foam to the surface of the object to be sanitized, enabling thereby to consume less chemicals than a non-foamed sanitizer. This foam is generated by a physical phenomenon (i.e. by mixing a gas under pressure with the composition, which gas generates bubbles upon expansion) generally using standard commercial equipment. The foam generated must adhere to the surface and not fall quickly off the surface after it is applied. This means that the surface of the liquid film of the foam must be elastic, preferably plastic, enough to prevent a rapid passage of water to the surface (which would cause the foam to either slip off the surface or retract). However, the surface of the film cannot be too plastic or else the diffusion of the peracid from the liquid film to the surface will be impeded, thereby reducing the efficacy of the antimicrobial agent. This problem is solved through the use of a retention aid which is preferably provided as a concentrate for admixture with the antimicrobial agent at point of use and comprises a mixture of a non-ionic surfactant, an ionic surfactant, and optionally a water-soluble magnesium ion source; or a mixture of a biopolymer thickening agent and at least one surfactant, and optionally a water-soluble magnesium ion source.

However, the solutions of U.S. Pat. No. 6,828,294 only contain up to 3000 ppm (0.3 wt %) of peracid (peracetic acid namely) and even with such a low concentration, the teaching of this document is to only mix the peracid with the retention aid just before use in order to prevent peracid decomposition.

A more concentrated peracid composition that is also suitable for physical foaming is commercialized by the company Diversey under the brand Diverfoam Active VT70. According to the information available in the safety data sheet data of this product, it contains 15-30 wt % hydrogen peroxide (H₂O₂), 5-15 wt % acetic acid (AcAc), less than 5 wt % of peracetic acid (PAA) and less than 5 wt % of a nonionic surfactant (namely coco alkyldimethyl, N-oxides, a mixture of amine oxides having the CAS registration N^{o} 61788-90). Its pH is below 2 which helps stabilizing the PAA (or favor the equilibrium reaction between AcAc and H2O2 which generates PAA). A chemical analysis of this product shows the additional presence of a low amount (less than 0.1 wt %) of fatty acids the origin of which is not quite clear (they might be residues of the amine oxides manufacturing which actually starts from fatty acids; or they could be the result of the degradation of the amine oxides by H2O2). Although this product seems to provide quite a good adherence and retention on non-horizontal surfaces, there is still some room for improvement with regard to these properties.

It is an object of the present invention to provide materials which can further thicken and foam aqueous compositions comprising peracetic acid to produce viscous foaming compositions which can be applied for disinfecting and/or cleansing purposes to non-horizontal surfaces and which are not restricted to very dilute peracid concentrations.

Therefore, the present invention concerns a process for the manufacture of an aqueous composition suitable for physical foaming comprising hydrogen peroxide, as claimed in claim 1.

The assignee has namely discovered that the combined use of amine oxides and fatty acids has a beneficial effect on the foam adherence and retention on non-horizontal surfaces but that the amount of fatty acids originating from the reaction between hydrogen peroxide and the amine oxide is not enough to observe that effect. He also discovered that in order for the fatty acids to remain soluble and not to precipitate out of the solution during storage, the sequence of adding the compounds of the composition is of utmost importance. Quite surprisingly indeed, provided said fatty acids are first dissolved into the acetic acid used for generating peracetic acid in situ, they will remain soluble afterwards, during the mixing of the other components and also, during storage even at low temperature.

The composition obtainable by the process of the present invention is suitable for physical foaming. This means that when it is first mixed with a gas under pressure (compressed air in general) into an equipment/device, when the pressure is released from the mixture upon exiting the equipment, the composition according to the invention generates a foam as a result of the expansion of the gas trapped in the mixture.

Peracetic acid may be present in a wide range of concentrations, but not below 1 wt %, more preferably not below 2 wt %. Preferably, peracetic acid is in a concentration below 5 wt %, more preferably below 4 wt %.

Amine oxides that can be employed in the present invention often contain generally from 10 to 24 carbons, usually including at least one long chain group, for example containing from 8 to 18 carbons, as a substituent of the N atom, the other substituents generally being short chain alkyl groups such as methyl, ethyl or propyl or hydroxyl substituted alkyl groups such as hydroxyethyl. The long chain alkyl group may be synthetically derived, or may be derived from natural products, for example coconut or tallow oil derivatives. Preferably, the at least one amine oxide used in the composition according to the present invention is lauramine oxide (LAO) and/or myristamine oxide (MAO).

According to an embodiment of the invention, at least two amine oxides are used. These may be introduced separately in the composition of the invention. Alternatively, commercially available mixtures of amine oxides may be used as for instance the afore mentioned coco alkyldimethyl, N-oxides having the CAS registration N^{o} 61788-90 and which are for instance available under the brand name Barlox®12.

Other commercially available amine oxides which can preferably be used in the frame of the invention are those which comprise both LAO and MAO like those that are available under the brand names Chemoxide™ Amine Oxides or AMMONYX® Amine Oxides. The latter give good results in the present invention and especially grade AMMONYX® LO which is an aqueous solution comprising 20-24 wt % LAO and 5-9 wt % MAO. Generally, between 5 and 20 wt % of this solution is used in the composition of the invention, preferably between 7 and 15 wt %, even more preferably between 8 and 12 wt % of the total composition is made of this solution.

Generally speaking, less than 5 wt % of amine oxide(s) are used in the composition of the invention, more preferably less than 4 wt %. At least 1 wt % of amine oxide(s) are preferably used in the composition of the invention, more preferably at least 2 wt %. Preferably, between 2 and 4 wt % of amine oxide(s) are used. By the terms “are used” it is intended to designate the amount added in the initial composition.

The pH of compositions obtainable by the process according to the present invention is preferably below 2.0, more preferably below 1.5. This low pH value is generally obtained using a mineral acid (preferably H2SO4), which actually helps to accelerate the formation of peracetic acid from the acetic acid and hydrogen peroxide (see below). Generally however, the pH is above 0, preferably above 0.5 even more preferably above 1.

The process according to the invention comprises adding on purpose at least one fatty acid to the other ingredients of the composition, which at least one fatty acid preferably is of the same nature as the one or those already present in situ. As is the case for the amine oxide of the present invention, the fatty acid usually includes at least one long chain group, for example containing from 8 to 18 carbons, preferably from 10 to 16 carbons. Preferably, lauric acid (LA) and/or myristic acid (MA) is used as the fatty acid(s) according to the invention. According to the invention, the amount of fatty acid added to the composition is at least 0.1 wt %, generally at least 0.2 wt %. As is the case for the above mentioned mixtures of LAO and MAO, the weight ratio between LA and MA, the case being, is generally from 2 to 5, preferably around 3.

More generally: as is the case for the above mentioned amine oxides, the fatty acids according to the invention, when there are at least 2 of them, can be introduced separately or as a mixture (like a commercially available one for instance).

Generally, the weight ratio between the total amount of fatty acid(s) and the total amount of amine oxides is higher than 0.05, preferably higher than 0.1.

The composition obtainable by the process of the present invention may include one or more stabilisers for peracids and/or hydrogen peroxide so as to favor its chemical stability. Known stabilisers for peroxygen compounds include aminopolycarboxylic acids, such as EDTA and DTPA, or N-heterocyclic aromatic carboxylic acids such as quinolinic acid, picolinic acid and dipicolinic acid (DPA). DPA is particularly effective. Other effective stabilizers comprise organic polyphosphonic acids, including hydroxyethylidene-diphosphonic acid (HEDP) and aminopolymethylene phosphonic acids. HEDP is particularly effective. A combination of any two or more of the aforementioned types of stabiliser can be employed. A combination of DPA and HEDP is particularly effective. The weight proportion of stabilisers in the invention composition is generally below 5 wt %, preferably below 2 wt %. Generally, the amount of HEDP is higher than 0.25 wt %, preferably higher than 0.5 wt %. However, it is generally below 4 wt %, preferably below 2 wt %. Generally, the amount of DPA is higher than 0.05 wt %, preferably higher than 0.1 wt %. However, it is generally below 1 wt %, preferably below 0.5 wt %.

The process of the invention comprises the steps of introducing a foaming system as herein described (namely comprising at least one amine oxide and at least one fatty acid) into a mixture of hydrogen peroxide and acetic acid (AcAc), optionally in the presence of a strong acid catalyst and/or of stabilizer(s) as described above; and allowing the peracid to form in situ. In other words, this process comprises the steps of mixing a selected amount (preferably as defined above) of at least one amine oxide and of at least one fatty acid with hydrogen peroxide and an organic acid, optionally in the presence of a strong acid catalyst and/or of stabilizer(s); and allowing the peracid to form in situ.

The AcAc may be glacial AcAc or diluted grade of AcAc, for instance having a concentration of less than 60 wt %, essentially for safety reasons. In any case, the final concentration of all ingredients may be adjusted by adding the required amount of DMW.

According to the invention, the at least one fatty acid is dissolved in AcAc, preferably glacial AcAc, in order to form a masterbatch which is thereafter mixed with the other ingredients of the composition (amine oxide(s), hydrogen peroxide and/or a PAA solution, stabilizer(s) the case being, and DMW) to reach the required final concentrations.

Especially when glacial AcAc is used, it is preferable to form the masterbatch in a separate, dedicated device which answers to the ATEX EU directives describing what equipment and work environment is allowed in an environment with an explosive atmosphere.

In a preferred embodiment which allows boosting the kinetics of peracid formation, the masterbatch also comprises a strong acid, preferably H2SO4.

According to a most preferred embodiment, the masterbatch is substantially free of water i.e. it does not comprise more than 0.1 wt % of water, preferably less than 0.05 wt % of water.

In one embodiment, the other ingredients of the composition i.e. hydrogen peroxide, eventually its stabilizers, the amine oxide(s) and the required adjustment of DMW, are provided as a second masterbatch to be mixed with the first one. Generally, the time between mixing the two masterbatches and the use of the final composition is in the range of the hours, preferably of the days.

It has been found that this last very preferred and convenient embodiment of the invention allows to obtain a composition which is stable even when stored at low temperature, for instance down to 6° C. or even down to 0° C. In a preferred embodiment of the invention, the use of a strong mineral acid is avoided. Although this has a negative effect on the kinetic of the peracid formation, it has the advantage of avoiding side reactions between components which lead to a low shelf life of the foaming composition.

In another embodiment of the invention, the other ingredients of the composition i.e. hydrogen peroxide, eventually its stabilizers, the amine oxide(s) and the required adjustment of DMW, are added separately to the masterbatch and the amine oxide(s) is added at the end, preferably in a device specifically dedicated thereto. It is namely so that this ingredient is likely to induce foaming right upon addition in the composition and it is of course not desirable that this foam would invade and contaminate the rest of the industrial facility. Eventually, the amine oxide(s) could be added by the end user right before use or inside the spray gun used for applying the foam.

The present invention also relates to foaming compositions that are obtainable by the process described above and that comprise hydrogen peroxide, peracetic acid in an amount of at least 1 wt % and at least one amine oxide, said foaming composition also comprising at least one fatty acid in an amount of at least 0.1 wt % with regard to the total weight of the composition, preferably in an amount of at least 0.2 wt %.

A further aspect of the present invention comprises the use of the aforementioned invention compositions for disinfecting and cleansing by applying the composition of the invention in the form of a foam to a hard surface and permitting contact to be maintained until at least some disinfection has occurred. Generally, the contact time is in the range of the minutes.

The invention compositions may be applied using conventional physical foaming means as described above, like a spray gun for instance. Generally, this device dilutes the composition of the invention with pressurized water and mixes it with pressurized air and upon its exit, foam is created. In one embodiment, the amine oxide(s) is added to the rest of the composition inside the spray gun.

The surfaces onto which the compositions may be applied are often industrial surfaces in the food and beverage industry and in other industries in which microorganisms may be found on hard surfaces. Suitable receptive surfaces are usually made from wood, glass, ceramics, plastic laminates and metal, generally stainless steel, and include work surfaces, sinks, pipework, walls, floors etc. Such potentially infected surfaces may be found in non-domestic situations such as in commercial kitchens, food processing apparatus or containers or brewery or distillery vessels or hospitals or in animal or poultry-rearing establishments or in glass houses or other areas where the maintenance of hygienic conditions is important. The present invention includes the use of invention compositions in such non-domestic situations, especially for stainless steel surfaces.

The present invention gives good results with non horizontal surfaces, which are difficult to clean with the prior art solutions.

The compositions may subsequently be removed from the surfaces by water washing. An easy way to do this practice is to use the same spray gun that has served for applying the compositions but to operate it with water only.

Having described the invention in general terms, specific embodiments thereof will now be described in greater detail by way of example only.

### EXAMPLES E1 TO E3

The following ingredients have been mixed, heated at about 40° C. and left to stand overnight. Their PAA concentration was of 3.5 wt % and their H2O2 concentration of 15 wt %.

| Chemicals (g) | E1 | E2 | E3 |
|---|---|---|---|
| AcAc | 303.53 | 303.53 | 303.53 |
| H2O2 | 1015.67 | 1015.67 | 1015.67 |
| LA | 1.40 | 2.45 | 1.40 |
| MA | 0.60 | 1.05 | 0.6 |
| AMMONYX ® LO | 216.66 | 186.66 | 186.66 |
| HEDP (60 wt % solution in H2O) | 20 | 20 | 20 |
| DPA (10 wt % solution in H2O) | 4.5 | 4.5 | 4.5 |
| DMW | 437.64 | 466.14 | 467.64 |
| Total weight | 2000 | 2000 | 2000 |

They have been sprayed and foamed (*) on a vertical surface made of stainless steel next to the above mentioned Diverfoam Active VT70. After 11 min, the latter has completely fallen off the surface while composition E1 to E3 were still present as a rather uniform foam.

(*) using a spray gun which sucked the different compositions by a Venturi effect using water at a pressure of 20 bar and with a dilution ratio of about 1%, and an air pressure of 6 bar.

These solutions tend to become cloudy (opaque) at about 0° C. and below.

Comparatively, a similar composition but containing additionally about 0.6 wt % H2SO4 and obtained by mixing 2 masterbatches (one containing all the acids, namely AcAc, LA, MA and H2SO4; and the other containing the reminder of the ingredients namely H2O2, HEDP, DPA, AMMONYX® LO and DMW (DeMineralized Water)) only becomes cloudy (opaque) at about −6° C. and below.

Should the disclosure of any patents, patent applications, and publications which are incorporated herein by reference conflict with the description of the present application to the extent that it may render a term unclear, the present description shall take precedence.

1. A process for the manufacture of an aqueous composition that comprises hydrogen peroxide, at least one fatty acid, at least one amine oxide, and at least 1 wt %, based on the total weight of the composition, peracetic acid and is suitable for physical foaming, comprising:
mixing a solution of the at least one fatty acid, present in an amount of at least 0.1 wt %, based on the total weight of the composition, in acetic acid with the-at least one amine oxide and hydrogen, peroxide optionally in the presence of a strong acid catalyst and/or of at least one stabilizer; and
allowing the peracetic acid to form in situ.

2. The process according to claim 1, wherein peracetic acid is in a concentration below 5 wt %.

3. The process according to claim 1, wherein the at least one amine oxide is lauramine oxide and/or myristamine oxide.

4. The process according to claim 1, wherein the composition has a pH below 2.0.

5. The process according to claim 1, wherein the at least one fatty acid added to the composition is lauric acid and/or myristic acid.

6. The process according to claim 1, wherein the mixing is in the presence of the stabilizer and the stabilizer comprises dipicolinic acid and hydroxyethylidene-diphosphonic acid.

7. The process according to claim 1, wherein the solution of the at least one fatty acid in acetic acid is in the form of a masterbatch and is formed in a separate, dedicated device that is compliant with ATEX EU directives.

8. The process according to claim 1, wherein the mixing is in the presence the strong acid catalyst, the solution of the at least one fatty acid in acetic acid is in the form of a masterbatch, and the masterbatch comprises the strong acid catalyst.

9. The process according to claim 1, wherein the solution of the at least one fatty acid in acetic acid is provided as a first masterbatch, other ingredients of the composition are provided as a second masterbatch, and the second masterbatch is mixed with the first masterbatch.

10. The process according to claim 1, wherein the solution of the at least one fatty acid in acetic acid is in the form of a masterbatch, other ingredients of the composition are added separately to the masterbatch, and the at least one amine oxide is added at the end.

11. A foaming composition comprising: hydrogen peroxide, at least one amine oxide, peracetic acid in an amount of at least 1 wt %, and at least one fatty acid in an amount of at least 0.1 wt %, wherein each amount is based on the total weight of the composition.

12. A method for disinfecting and cleansing, comprising applying it a composition according to claim 11 in the form of a foam to a hard surface and permitting contact to be maintained until at least some disinfection has occurred.

13. The method according to claim 12, wherein the composition is applied using a spray gun and the at least one amine oxide is added to the composition inside the spray gun.

14. The method according to claim 12, wherein the hard surface is made of stainless steel.

15. The process of claim 1, wherein the solution of the at least one fatty acid in acetic acid is a solution of the at least one fatty acid in glacial acetic acid.

16. The process according to claim 4, wherein the composition comprises a mineral acid.

17. The process according to claim 4, wherein the masterbatch comprises H₂SO₄.

18. The process according to claim 8, wherein the masterbatch comprises a mineral acid.

19. The process according to claim 18, wherein the mineral acid is H₂SO₄.

20. The process according to claim 8, wherein the strong acid is H₂SO₄.
